(19) United States
(12) Patent Application Publication
(10) Pub. No.: US 2014/0346780 A1
(43) Pub. Date: Nov. 27, 2014

(54) CONNECTION ASSEMBLY FOR A POWER SYSTEM

(71) Applicant: Progress Rail Services Corporation, Albertville, AL (US)

(72) Inventor: Stuart Charles Holder, Pekin, IL (US)

(73) Assignee: Progress Rail Services Corporation, Albertville, AL (US)

(21) Appl. No.: 13/899,067

(22) Filed: May 21, 2013

(51) Int. Cl. H02K 7/18; F16C 3/02; H02K 15/14

(52) U.S. Cl. CPC H02K 7/1815; H02K 15/14; F16C 3/02
USPC 290/1 A; 310/75 R; 29/598; 464/182

(57) ABSTRACT

A connection assembly for a power system is disclosed. The connection assembly may have a housing configured to be connected to a stationary portion of a generator and a bearing operatively connected to the housing. The connection assembly may also have a shaft supported by the bearing and configured to be connected to a rotor of the generator. The connection assembly may additionally have an adapter coupled to the housing and configured to be connected to an engine. The shaft may extend through an opening in the housing and an opening in the adapter to connect with a crankshaft of the engine.

### TECHNICAL FIELD

The present disclosure is directed to a connection assembly and, more particularly, a connection assembly for a power system.

### BACKGROUND

Power systems often include engines operatively connected to one or more generators (e.g., an alternator). The generator(s) convert mechanical energy into electricity, which may be stored and subsequently used to provide power to another part of the power system (e.g., a traction motor). For example, a crankshaft of an engine may be rotatably connected to a rotor of a generator that creates electricity through rotation within a stator. In some power system applications, it may be desirable to replace the engine currently in-use with another engine, such as an engine that is more efficient, produces lower emissions, etc. However, the replacement engine may not be readily connectable with the existing generator components. Modifications may be necessary to connect the replacement engine with the existing generator.

One example of a generator connected to an engine is disclosed in U.S. Patent Application Publication 2010/0295005 of Wolff et al. (“the '625 publication”). In particular, the '625 publication discloses a power system including an electrical converting device and a “repowered” portion including a replacement internal combustion engine. The repowered portion further includes a gearbox and a pair of connecting structures that operatively connect an output member of the internal combustion engine to the gearbox and the gearbox to an input member of the electrical converting device. The engine output member thereby drives the electrical converting device input member through the gearbox and connecting structures. A separate support is rigidly mounted to a support frame to provide support to a driven end of the electrical converting device.

While the '625 publication discloses a modified connection between an engine and a generator, it may be less that optimal. In particular, the use of two connecting structures and a gearbox to connect the engine to the generator may be bulky, especially considering the limited amount of space available in a typical power system application. Similarly, use of a separate support mounted to the support frame may be impractical for applications in which there is limited space between the engine and the generator. In addition, the input shaft of the generator may not be readily connectable to a connecting structure.

The present disclosure is directed to overcoming one or more of the problems set forth above and/or other problems of the prior art.

### SUMMARY

In one aspect, the present disclosure is directed to a connection assembly for a power system. The connection assembly may include a housing configured to be connected to a stationary portion of a generator and a bearing operatively connected to the housing. The connection assembly may also include a shaft supported by the bearing and configured to be connected to a rotor of the generator. The connection assembly may additionally include an adapter coupled to the housing and configured to be connected to an engine. The shaft may extend through an opening in the housing and an opening in the adapter to connect with a crankshaft of the engine.

In another aspect, the present disclosure is directed to a shaft extension for a connection assembly. The shaft extension may include a connection plate configured to be connected to a connection surface on an existing generator. The shaft extension may also include a shaft extending from the connection plate and configured to connect to a securing member on an engine. The shaft extension may be configured to support a bearing to convert the existing generator from a single-bearing generator to a dual-bearing generator

In another aspect, the present disclosure is directed to a method of connecting components of a power system. The method may include connecting a shaft to a rotor of a generator and connecting a housing to a stationary portion of the generator such that the shaft extends through an opening in the housing. The method may also include supporting the shaft with a bearing connected to the housing. The method may additionally include moving the engine to align an axis defined by a securing member with an axis defined by the shaft.

### BRIEF DESCRIPTION OF THE DRAWINGS

FIG. 1 depicts an exemplary disclosed power system;

FIGS. 2-3 depict exploded views of an exemplary disclosed connection assembly that may be used in conjunction with the power system of FIG. 1;

FIGS. 4 depicts an exemplary disclosed extension shaft that may be used in conjunction with the connection assembly of FIGS. 2-3;

FIGS. 5A-5B depict an exemplary disclosed bearing housing that may be used in conjunction with the connection assembly of FIGS. 2-3; and

FIG. 6 depicts an exemplary disclosed adapter that may be used in conjunction with the connection assembly of FIGS. 2-3.

### DETAILED DESCRIPTION

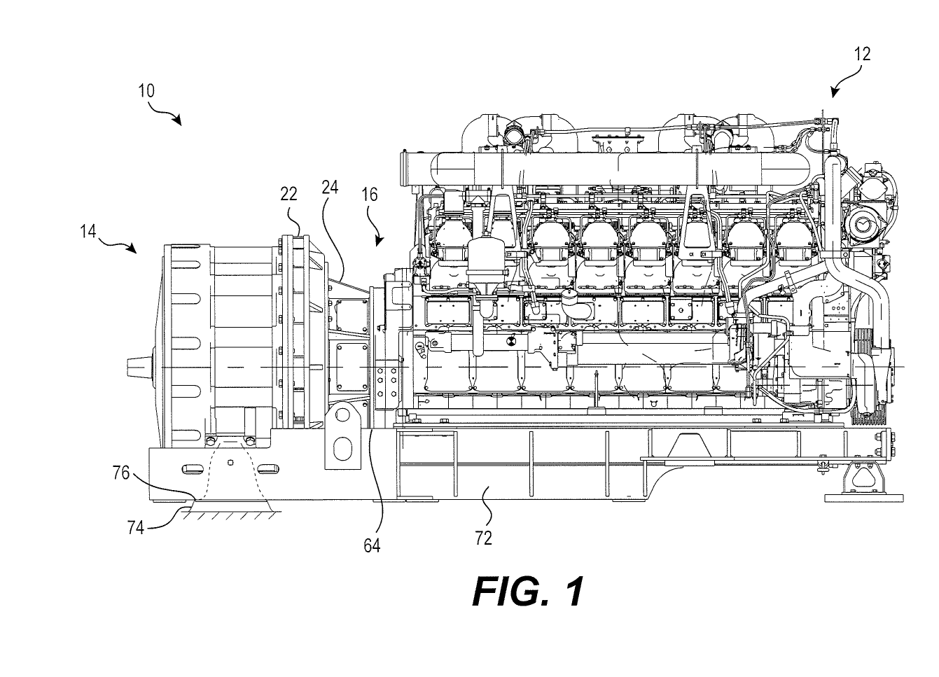

FIG. 1 illustrates an exemplary power system 10 consistent with certain disclosed embodiments. Power system 10 may include an engine 12 coupled to a generator 14 via a connection assembly 16. Engine 12 may be an internal combustion engine such as a diesel engine, a gasoline engine, or a gaseous-fuel powered engine that combusts a mixture of fuel and air. For example, engine 12 may be a four-cycle, diesel-fueled engine having sixteen cylinders. One skilled in the art will recognize, however, that engine 12 may be any other type of combustion engine or a non-combustion engine capable of producing mechanical output. Generator 14 may be, for example, an AC induction generator, a permanent-magnet generator, an AC synchronous generator, or a switched-reluctance generator that is mechanically driven by engine 12 to produce electrical power. Connection assembly 16 may connect an output member of engine 12 to an input member of generator 14. For example, connection assembly 16 may operatively connect a crankshaft (not shown) of engine 12 to a rotor (not shown) of generator 14 to transfer rotational motion from engine 12 to generator 14.

Connection assembly 16 may include components configured to provide support and maintain alignment between engine 12 and generator 14. These components may include, among other things, a housing 22 connected to generator 14, and an adapter 24 connected to a flywheel housing 64 of engine 12. In an exemplary embodiment, connection assembly 16 may be a retrofit assembly configured to secure a generator 14, originally connected to another engine, to a replacement engine 12.

As further shown in FIG. 1, power system 10 may include a common base 72 that extends below engine 12 and generator 14. Common base 72 may be arranged to support engine 12 such that movement of common base 72 results in movement of engine 12. Generator 14 may be supported by base feet 74. Base feet 74 may extend through openings 76 (only one shown) in common base 72 to be connected to a support surface beneath common base 72. In this way, common base 72 may be adjusted to move engine 12 relative to generator 14, since movement in common base 72 does not result in movement of base feet 74.

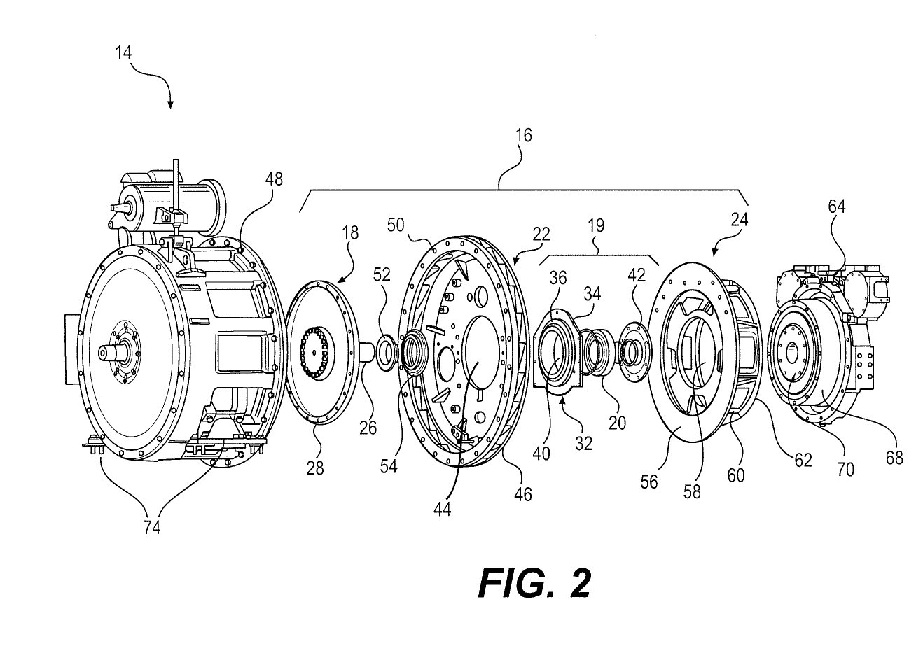

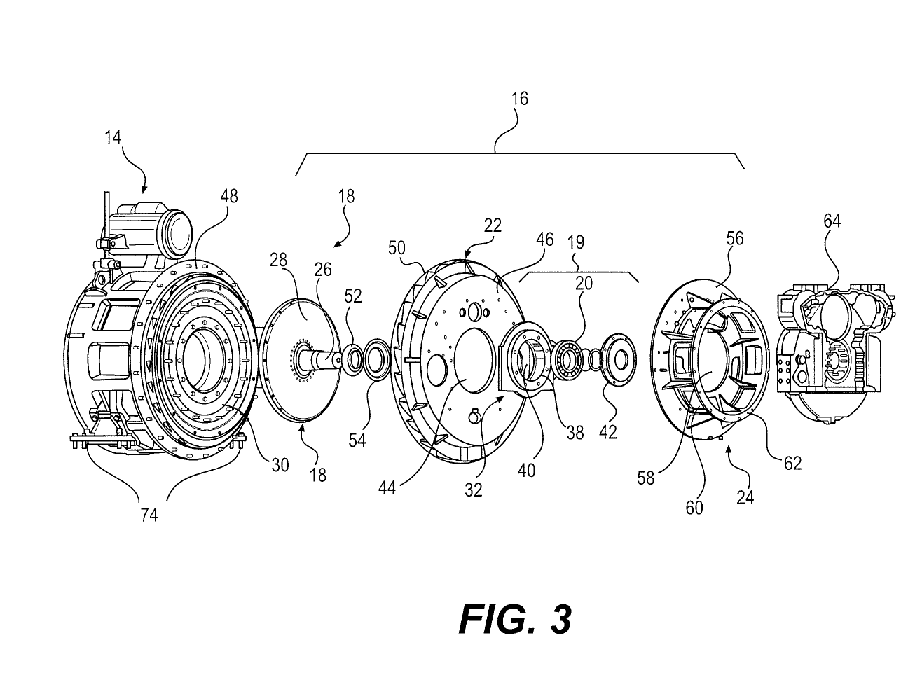

As shown in FIGS. 2-3, connection assembly 16 may include (e.g., in addition to housing 22 and adapter 24) a shaft extension 18 and a bearing assembly 19. Shaft extension 18 may include a shaft 26 and a connector 28. Connector 28 may be configured to connect shaft extension 18 to a connection surface 30 on the rotor of generator 14, such that shaft extension 18 may rotate with the rotor.

In an exemplary embodiment, shaft extension 18 and bearing assembly 19 may be components added to an existing generator 14 to convert generator 14 from a single-bearing generator to a dual-bearing generator. For example, the rotor of generator 14 may be supported by an original bearing (not shown) provided on a non-connection end of generator 14 (i.e., end of generator 14 distal to engine 12). Connection assembly 16 may provide bearing assembly 19, including a bearing 20, as the additional bearing on a connection end of generator 14 (i.e., end of generator 14 proximal to engine 12) for further supporting rotational components of power system 10, specifically shaft extension 18. While bearing 20 is described herein as a ball bearing, it should be understood that bearing 20 could be another type of bearing, such as a journal bearing, magnetic bearing, or any other type of bearing known in the art.

Bearing assembly 19 may include bearing 20, a bearing housing 32, a cover 42, a cap 52, and a gasket 54. Bearing 20 may be supported on shaft 26 of shaft extension 18 and held in bearing housing 32. Bearing housing 32 may include an outer surface 34, a first protrusion 36, a second protrusion 38 on a side opposite first protrusion 36, and a through bore 40. Bearing 20 may be sized to fit within bearing housing 32. For example, bearing 20 may be a circular ball-bearing case with an outer diameter configured to fit in through bore 40 of bearing housing 32 and an inner diameter sized to receive shaft 26. Cover 42 may be secured to bearing housing 32 to close off one side of through bore 40. Cap 52 and gasket 54 may be placed on the other side of through bore 40 to seal bearing 20 within bearing housing 32. Cover 42, cap 52, and gasket 54 may each include openings through which shaft 26 may extend.

Bearing housing 32 may be secured to housing 22 to connect bearing assembly 19 to generator 14. In an exemplary embodiment, housing 22 may be an original housing associated with an engine previously connected to generator 14. For example, housing 22 may be a flywheel housing originally associated with the replaced engine. Housing 22 may include a circular opening 44, an exterior surface 46, and a rim portion 50. First protrusion 36 of bearing housing 32 may be configured to extend into circular opening 44 in housing 22 to guide attachment of bearing housing 32 to housing 22. Fasteners (e.g., bolts) may extend through holes in an exterior surface 46 of housing 22 and holes in outer surface 34 of bearing housing 32 to secure the components together. Housing 22 may be secured to a stationary portion of generator 14 by fasteners extending through holes in an outer edge 48 of generator 14 and rim portion 50 of housing 22. While fasteners inserted through corresponding holes are described as connection members throughout this disclosure, it should be understood that other types of fastening means, such as gluing, welding, etc., may be used. With housing 22 and bearing housing 32 attached to generator 14, shaft 26 may extend through circular opening 44, through bore 40, and bearing 20.

Adapter 24 may be provided to secure housing 22 to engine 12. Adapter 24 may include an attachment member 56 configured to be secured to housing 22, and an extension portion 60 configured to be secured to engine 12. Attachment member 56 may include a plurality of holes configured to be aligned with holes in exterior surface 46 of housing 22 for receiving fasteners therethrough. Second protrusion 38 of bearing housing 32 may be configured to extend into circular opening 58 to guide attachment of attachment member 56 to exterior surface 46 of housing 22. Extension portion 60 may include a circular rim 62 configured to be secured to engine 12, such as to an edge of flywheel housing 64.

Components of engine 12 may be configured to fit within an opening defined by extension portion 60. For example, flywheel components 68 may be configured to fit within extension portion 60 to allow a securing member 70 to be secured on an end of shaft 26 of shaft extension 18, which extends through an opening defined by attachment member 56 of adapter 24. In an exemplary embodiment, securing member 70 may be a pressure-fit cap that is secured to an end of shaft 26 of shaft extension 18 for transferring torque from the flywheel of engine 12 to shaft 26. Securing member 70 may be secured to the flywheel of engine 12, either directly or indirectly, such that rotation of the flywheel results in corresponding rotation of securing member 70. The flywheel may be connected to the crankshaft of engine 12 such that rotation of the crankshaft results in rotation of the flywheel, which is transferred to the shaft extension 18 and eventually to the rotor of generator 14. In this way, connection assembly 16 may be utilized to transfer torque and rotatably drive the rotor of generator 14. Bearing 20 may provide support to connection assembly 16 to help prevent orbiting and/or vibrating that may damage components of power system 10 and prevent efficient transfer of energy.

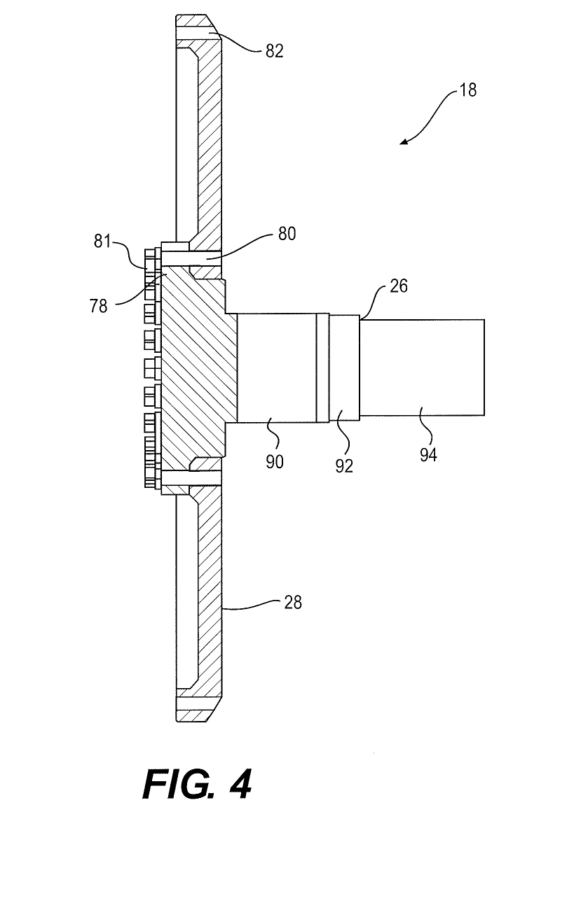

FIG. 4 further depicts shaft extension 18. Shaft 26 may have a generally cylindrical shape including a plurality of diameters, each diameter defining a section that may accommodate one or more components supported by shaft extension 18 (e.g., bearing 20, cover 42, cap 52, securing member 70). For example, shaft 26 may include a first section 90 sized to accommodate and support cap 52 and bearing 20, a second section 92 sized to accommodate and support cover 42, and a third section 94 sized to accommodate and be secured to securing member 70. In an exemplary embodiment, shaft 26 and connector 28 may be formed separately and joined by fasteners. For example, shaft 26 may include a flange 78 configured to abut a surface of connector 28 and align holes 80 for receiving fasteners 81 therethrough. In an alternative embodiment, shaft 26 and connector 28 may be integrally formed as one piece. In either embodiment, connector 28 may be a connection plate configured to mate with connection surface 30 on the rotor of generator 14. Shaft extension 18 may be secured to generator 14 by fasteners inserted through holes 82 in connector 28 and holes in connection surface 30.

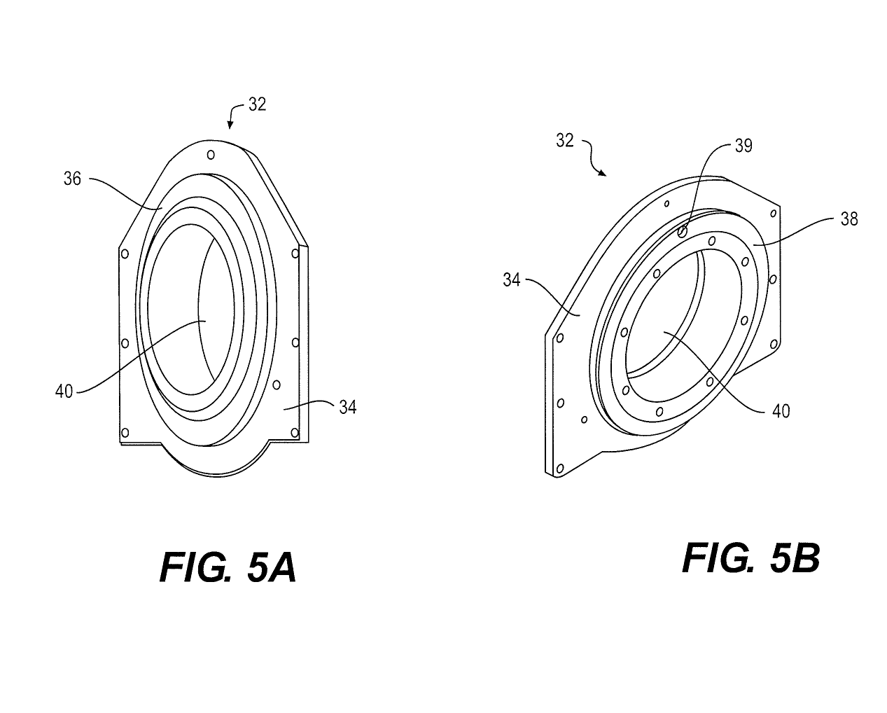

FIGS. 5A-5B further depict bearing housing 32. Outer surface 34 may be a generally planar surface extending away from first and second protrusions 36, 38. Outer surface 34 may include holes for receiving fasteners to attach bearing housing 32 to exterior surface 46 of housing 22. First and second protrusions 36, 38 may be cylindrical protrusions configured to extend into circular openings 44, 58 of housing 22 and adapter 24, respectively. Bearing housing 32 may further include a fluid passage 39 configured to allow lubricant to be directed to bearing 20. For example, fluid passage 39 may include a channel formed in bearing housing 32 that fluidly communicates through bore 40 with an exterior of bearing housing 32.

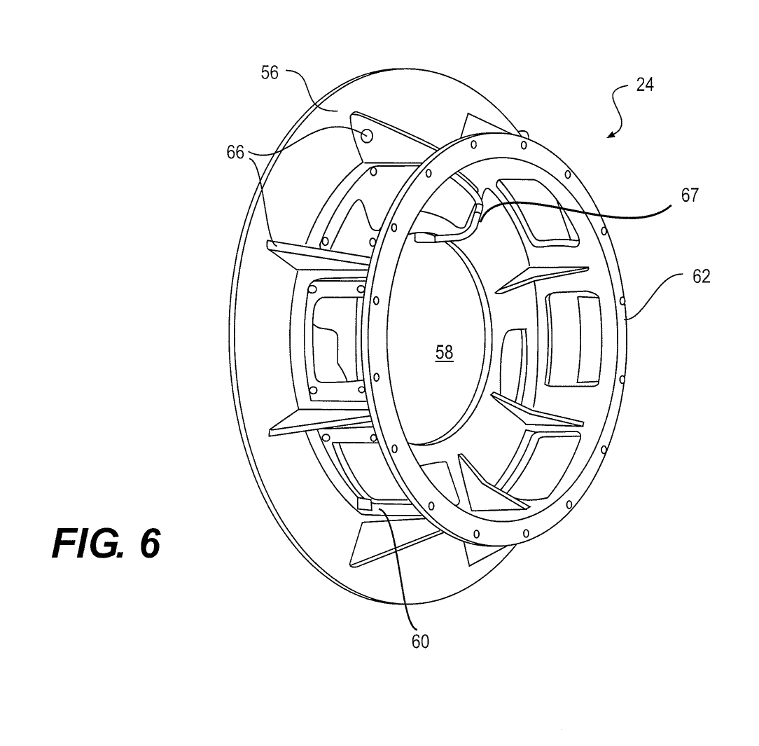

FIG. 6 further depicts adapter 24. Attachment member 56 may be a ring-shaped panel with holes for receiving fasteners to attach adapter 24 to exterior surface 46 of housing 22. Circular rim 62 may also be a ring-shaped panel with holes for receiving fasteners to attach adapter 24 to flywheel housing 64 of engine 12. In an exemplary embodiment, an outer diameter of attachment member 56 may be larger than an outer diameter of circular rim 62. This difference in size may allow for a secure connection between exterior surface 46 of housing 22 and flywheel housing 64, which may have a smaller diameter than housing 22. Extension portion 60 may also include a plurality of reinforcing members 66 connected between circular rim 62 and attachment member 56 to provide strength and rigidity to adapter 24. A fluid passage 67 (e.g., a hose or tube) may be connected to adapter 24 and fluidly connected to fluid passage 39 to allow lubricant to be directed from a reservoir (not shown), through fluid passages 67, 39, to bearing 20.

### INDUSTRIAL APPLICABILITY

The disclosed connection assembly 16 may be applicable to any power system 10 in which torque is transferred from one component to another. The connection assembly 16 may be particularly beneficial when utilized to connect a power source (e.g., engine 12) to a generator/alternator (e.g., generator 14). Further, connection assembly 16 may be applicable to introduce an additional bearing 20 to support rotational components. For example, the disclosed connection assembly 16 may be utilized to convert a single-bearing generator into a dual-bearing generator. An exemplary process for converting such a generator is described below.

An existing power system 10 may include an existing engine (not shown) operatively connected to generator 14. The existing engine may be replaced with engine 12 to update power system 10 by including a power source that, for example, is more efficient, has higher power, produces lower emissions, etc. It may be beneficial to continue to use generator 14 as part of power system 10 to, for example, reduce the number of parts to be replaced, reduce costs of updating power system 10, etc.

In an exemplary disclosed embodiment, generator 14 may be a locomotive alternator supported by a single bearing at the far end of generator 14 and connected to the existing engine by housing 22. For example, housing 22 may be a flywheel housing of the existing engine. In replacing the existing engine with the new engine 12, flywheel housing 64 may be incompatible for direct connection to generator 14. Connection assembly 16 may be implemented to accommodate an operative connection between the crankshaft/flywheel of the new engine 12 and the rotor of the existing generator 14.

After the existing engine has been separated from power system 10, generator 14 may be modified to accommodate connection to the new engine 12. First, shaft extension 18 may be attached to connection surface 30 of the rotor of generator 14. The connection between connector 28 and connection surface 30 may be adjusted to prevent orbiting and/or vibrating of shaft 26 as it rotates with the rotor. For example, a shimming process may be used to incrementally adjust the connector 28 (e.g., adjust the alignment of connector 28 with respect to connection surface 30, the tension placed on connector 28 by the fasteners, etc.) until proper alignment (i.e., rotation with orbiting and/or vibrating below a threshold level) is achieved.

After shaft extension 18 has been secured to the rotor, housing 22 may be reattached to generator 14. For example, outer edge 48 of generator 14 may be secured to rim portion 50 of housing 22 by fasteners extending though aligned holes. With housing 22 secured to generator 14, shaft extension 18 may be enclosed by generator 14 and housing 22, except for shaft 26 extending out of circular opening 44 in exterior surface 46 of housing 22.

Bearing 20 and bearing housing 32 may be secured to housing 22 to provide further support to shaft 26 of shaft extension 18. Bearing 20 may be secured within bearing housing 32, which can be completed before or after bearing housing 32 is secured to housing 22 and/or adapter 24. Bearing 20 may be secured in through bore 40 of bearing housing 32 by cover 42 on one side (e.g., side proximal engine 12) and by cap 52 and gasket 54 on the opposite side (e.g., side proximal generator 14).

Either before or after housing 22 is secured to generator 14, bearing housing 32 may be secured to housing 22. First protrusion 36 may be inserted into opening 44 to guide attachment of bearing housing 32 to housing 22. With first protrusion 36 inserted into opening 44, fasteners may be inserted through holes in outer surface 34 of bearing housing 32 and exterior surface 46 of housing 22. With bearing housing 32 attached to housing 22 and housing 22 attached to generator 14, shaft 26 of shaft extension 18 may extend through circular opening 44 and through bore 40 such that bearing 20 supports shaft 26. Shaft 26 may be configured to extend beyond cover 42 when these components are in place.

Next, adapter 24 may be attached to housing 22. Second protrusion 38 of bearing housing 32 may be inserted into opening 58 to guide attachment of adapter 24 to housing 22. With second protrusion 38 inserted into opening 58, fasteners may be inserted through holes in attachment member 56 of adapter 24 and exterior surface 46 of housing 22. With adapter 24 attached to housing 22, shaft 26 may extend through opening 58 into extension portion 60.

With adapter 24 set in place, replacement engine 12 may be supported by common base 72 and moved into position for operative connection to generator 14. Engine 12 may be placed on common base 72 with flywheel housing 64 of engine 12 generally arranged such that an axis through a center of the securing member 70 is generally aligned with an axis through a center of shaft 26. An adjustment process may be utilized to adjust the position of engine 12 to refine the alignment of these axes, such that securing member 70 can be secured to an end of shaft 26 and circular rim 62 can be secured to flywheel housing 64. For example, common base 72 may be incrementally adjusted in one or more directions (e.g., up or down and/or side to side) to adjust the position of engine 12. Since generator 14 is supported by base feet 74, which are not attached to common base 72, movement of common base 72 may result in movement of engine 12 relative to generator 14, allowing for gradual alignment.

After securing member 70 has been generally aligned with shaft 26, engine 12 may be moved toward generator 14 until securing member 70 is secured on an end of shaft 26. Thereafter, adapter 24 may be attached to flywheel housing 64, such as by placing fasteners through aligned holes in circular rim 62 and an outer edge portion of flywheel housing 64. After all components are connected, engine 12 may be arranged to transfer rotational energy from the crankshaft to the rotor of generator 14. After initial operations (e.g., test runs), additional adjustment of the position of engine 12 may be necessary to achieve sufficient alignment of shaft 26 with the rotating members of engine 12. If necessary, proper alignment may be accomplished by additional incremental movement of common base 72.

With all components in place and sufficiently aligned, power system 10 may be operated. Power production (e.g., from combustion events in cylinders of engine 12) may result in rotation of the crankshaft of engine 12, which may cause the flywheel within flywheel housing 64 to rotate. Rotation of the flywheel may produce corresponding rotation of securing member 70, which may transfer torque to shaft 26 of shaft extension 18. Bearing 20 may support shaft 26 as the transferred torque causes shaft extension 18 to rotate and thus may help prevent shaft 26 from orbiting and/or vibrating beyond an allowable degree. Rotation of connector 28 of shaft extension 18 may cause rotation of fan 31 and the rotor of generator 14. Rotation of the rotor within a stator of generator 14 may convert the mechanical rotational energy into electricity, which may be stored and transferred to another component of power system 10, such as a traction motor for driving traction devices.

Since the replacement engine 12 may produce higher power and torque than the replaced engine, the dual-bearing arrangement provided by bearing 20 (when combined with the original far-end bearing) may be necessary to support rotation of the relevant components of power system 10. For example, the dual-bearing arrangement may prevent orbiting and/or vibrating that may cause damage to or inefficient operation of engine 12, generator 14, and/or connection assembly 16. Further, use of shaft extension 18 and adapter 24 may allow for housing 22 to be repurposed from a flywheel housing to a connection member that supports bearing housing 32 and bearing 20. In addition, the arrangement of common base 72 may allow for simpler alignment of rotational components by allowing engine 12 to easily be moved relative to generator 14.

It will be apparent to those skilled in the art that various modifications and variations can be made to the connection assembly of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A connection assembly for a power system having an engine and a generator, comprising:
a housing configured to be connected to a stationary portion of the generator;
a bearing operatively connected to the housing;
a shaft supported by the bearing and configured to be connected to a rotor of the generator; and
an adapter coupled to the housing and configured to be connected to the engine,
wherein the shaft extends through an opening in the housing and an opening in the adapter to connect with a crankshaft of the engine.

2. The connection assembly of claim 1, further including a bearing housing connected to the housing and the adapter, wherein the bearing is disposed in the bearing housing.

3. The connection assembly of claim 2, wherein the bearing housing includes a first protrusion configured to fit into the opening in the housing and guide attachment of the bearing housing to the housing.

4. The connection assembly of claim 3, wherein the bearing housing further includes a second protrusion configured to fit into the opening in the adapter and guide attachment of the adapter to the housing.

5. The connection assembly of claim 3, further including:
a first fluid passage attached to the adapter; and
a second fluid passage formed in the bearing housing, the second fluid passage connected to the first fluid passage to allow lubricant to be directed from a reservoir to the bearing.

6. The connection assembly of claim 1, further including a connection plate attached to an end of the shaft and configured to connect with a connection surface of the rotor.

7. The connection assembly of claim 1, wherein the adapter includes:
a circular panel connected to the housing; and
a circular rim configured to be connected to the engine.

8. The connection assembly of claim 7, wherein an outer diameter of the circular panel is larger than an outer diameter of the circular rim.

9. The connection assembly of claim 7, wherein the adapter further includes reinforcing members connected between the circular panel and the circular rim.

10. The connection assembly of claim 1, further including a securing member connected to an end of the shaft and configured to engage a flywheel of the engine.

11. The connection assembly of claim 1, further including a common base configured to extend beneath the generator and the engine, wherein movement of the common base causes movement of the engine relative to the generator.

12. A shaft extension for a connection assembly, comprising:
a connection plate configured to be connected to a connection surface on an existing generator; and
a shaft extending from the connection plate and configured to connect to a securing member on an engine,
wherein the shaft extension is configured to support a bearing to convert the existing generator from a single-bearing generator to a dual-bearing generator.

13. The shaft extension of claim 12, wherein the shaft includes a flange that abuts a portion of the connection plate.

14. The shaft extension of claim 13, further including fasteners inserted through holes in the flange and the connection plate to connect the shaft to the connection plate.

15. The shaft extension of claim 12, wherein the shaft and the connection plate are integrally formed as one piece.

16. The shaft extension of claim 12, wherein the shaft includes a generally cylindrical shape having a plurality of diameters, each diameter defining a section configured to support a component of a bearing assembly.

17. The shaft extension of claim 12, wherein the connection plate includes holes configured to receive fasteners to connect the shaft extension to the connection surface.

18. A method of connecting components of a power system, comprising:
connecting a shaft to a rotor of a generator;
connecting a housing to a stationary portion of the generator, wherein the shaft extends through an opening in the housing;
supporting the shaft with a bearing connected to the housing; and
moving the engine to align an axis defined by a securing member with an axis defined by the shaft.

19. The method of claim 18, wherein connecting the shaft to the rotor includes connecting a connector plate attached to the shaft to a connection surface on the rotor.

20. The method of claim 18, further including connecting the shaft to a flywheel of the engine via a securing member.

21. The method of claim 18, wherein moving the engine includes moving a common base that extends beneath the generator and the engine.

22. A power system, comprising:
an engine including a crankshaft;
a generator including a rotor;
a connection assembly configured to connect the crankshaft to the rotor, the connection assembly comprising:
a housing connected to a stationary portion of the generator;
a bearing operatively connected to the housing;
a shaft supported by the bearing and connected to the rotor;
an adapter coupled to the housing and the crankshaft;
a bearing housing configured to house the bearing and be connected to the housing and the adapter; and
a securing member connected to an end of the shaft and the crankshaft.

23. The power system of claim 22, further including a common base configured to extend beneath the generator and the engine.

24. The power system of claim 23, further including a support foot that extends through an opening in the common base to engage a support surface.

25. The power system of claim 23, wherein adjustment of the common base results in movement of the engine relative to the generator.
